(19) United States
(12) Patent Application Publication
(10) Pub. No.: US 2025/0269559 A1
(43) Pub. Date: Aug. 28, 2025

(54) TRANSLUCENT NATURAL ROCK SHEET ASSEMBLY APPLIED AS A DECORATIVE CLADDING AND DEVICE AND PRODUCTION PROCESS

(71) Applicant: Marcelo Favoreto SILVA, Muniz Freire (BR)

(72) Inventor: Marcelo Favoreto SILVA, Muniz Freire (BR)

(21) Appl. No.: 18/855,233

(22) PCT Filed: Apr. 5, 2023
(86) PCT No.: PCT/BR2023/050113

§ 371 Date: Oct. 8, 2024

(30) Foreign Application Priority Data
Apr. 9, 2022 (BR) 1020220068909
Apr. 5, 2023 (BR) 1020230063861

(51) Int. Cl. B28D 1/00; G02B 27/28

(52) U.S. Cl. CPC B28D 1/003; G02B 27/28

(57) ABSTRACT

This patent describes a new type of decorative cladding, consisting of an assembly whose main element is a translucent natural stone sheet (LR), interposed by polarized films (PP) which, when subjected to a light source (FL), show optical phenomena in the minerals contained in the sheet, providing the observer with unusual colors, effects and textures. It includes a thinning device (DDD) which is equipped with conveyor belts (EST); equipped with a plurality of horizontal skids (PAH), preferably with a flap, fixed below the belt (EST), helping to support the support grid (PS); and is equipped with a plurality of thinning modules (MD), responsible for producing the aforementioned sheets of translucent natural stone.

### FIELD OF THE INVENTION

This patent relates to a new type of decorative cladding, consisting of an assembly whose main element is a translucent natural stone sheet, interposed by polarized films which, when subjected to a light source, display optical phenomena in the minerals contained in this sheet, providing the observer with unusual colors, effects and textures. It also reveals a device for producing the translucent natural stone sheets used, with application in the technical field of construction, architecture and interior design, more specifically in the ornamental stone sector. The proposed device makes it possible to produce translucent stone sheets on a large scale and in large dimensions, and can be modified depending on the purpose of the product. It also includes the preferred process for transforming the translucent natural stone sheet into a decorative cladding.

### BACKGROUND TO THE INVENTION

As petrology experts in the field know, the optical effect of birefringence gives unusual colors and textures to the minerals present in a rock sheet, when observed by a transmitted light polarizing microscope, also known as a petrographic microscope, allowing minerals to be identified based on their crystallographic arrangement. And optical anisotropy is a crystallographic characteristic of certain minerals, where the physical properties of their crystallographic arrangement become different depending on the direction in which they are analyzed.

Each type of mineral, with anisotropic properties, subjected to this polarized light will behave in a unique way in terms of color, texture and other technical characteristics, due to the phenomenon called pleochroism. This phenomenon then makes it possible to analyze the properties and compositions of different types of rock, and is commonly used in academia.

The ornamental stone sector is a wide-ranging industry that essentially uses any stone material as a cladding, performing its aesthetic and/or structural function in a construction project. The ornamental stone production chain is complex and includes a range of different rock materials, different extraction methods, processing methods and product formats. Characteristics that vary according to each region of the world, taking into account mineral availability, access to extraction and processing technology and demand from the construction industry. However, the most widely used method of extraction, processing and marketing throughout the world, including Brazil as one of the world's leading powers in this sector, is the mineral extraction of solid rock in the form of parallelepiped blocks, which are then broken down into sheets, usually 2 cm to 3 cm thick, where these sheets go through a polishing process and become suitable for the final stage of processing, which involves industries using specific machinery to transform these sheets into flooring, worktops, sinks, façades, etc., arriving at the final product used in construction.

In order to better define the state of the art, we searched national and international patent databases and found the following relevant prior art.

The Brazilian utility model MU9102694U2, entitled “Production process for ornamental rock sheets with a thickness of 7 mm (seven millimeters)”, describes a method that makes use of diamond wires to cut blocks of rock into small thicknesses. When the block of rock is immobilized, a diamond wire loom makes the cut a first time, the block is then immobilized again and a second cut is made between the initial cuts, making it possible to produce sheets with thicknesses of 7 mm.

The process proposed by the MU9102694U2 model makes use of a diamond wire loom machine and requires the block to be clamped again after a first cut, reducing efficiency, the diameter of the plates obtained is not sufficient for petrographic sheets to be produced, for the execution of the process proposed by the model it is necessary to use a diamond wire loom, being completely different from the one proposed.

Portuguese patent PT101830B, entitled “Polishing machine with cylinders for polishing ornamental stones”, describes a machine consisting of a conveyor belt on which cylinders have been placed whose axes are perpendicular to the center of the bases and parallel to the transport screen. The sheets of ornamental stone transported by the conveyor belt come into contact with the underside of the rollers, the first for grinding and the last for polishing, while perforated tubes spray water onto the contact surface of each roller with the stone.

The main purpose of the device proposed by patent PT101830B is to thin and polish ornamental stone for use in construction, i.e. thinning and polishing are not carried out with the great precision required to produce petrographic sheets, which must have diameters of less than 1 mm.

Chinese utility model CN204855236U, entitled “Grinding machine model for coal petrography”, reveals an intelligent device that grinds and prepares petrographic samples for laboratory testing. The device is automatic and makes use of a rotary polisher that allows 3 samples to be prepared in succession.

Chinese patent CN106769332A, entitled “Multifunctional sample processing equipment and method of use”, discloses a cutting device for petrographic samples in which the sample is clamped under a control mechanism, the cutting is carried out in the path defined by the positioning mechanism, thus realizing fast and accurate processing of experimental samples of different sizes.

Utility model CN204855236U and patent CN106769332A, both Chinese, present devices to aid laboratory analysis in which the experimental samples produced have small dimensions, generally less than 20 cm². Unlike the device proposed by this patent, which can produce petrographic slides with areas of more than 1 m².

U.S. Pat. No. 3,649,100A, entitled “Polarizing slide projector unit”, discloses a projector that makes use of slides of petrographic rock slides and a polarizing support adapted to be positioned in the light system of a conventional slide projector to project an image of the rock slide onto a projection screen surface. The slides are made up of petrographic slides between two polarizing filter panels positioned with polarization axes mutually crossed in relation to each other.

The device proposed by patent U.S. Pat. No. 3,649,100A is mainly used in the academic field, making it easier for several people to analyze the same sample at the same time. The device is designed for small slides, which can be fitted into a projector, unlike the device in this patent, which uses and produces petrographic slides, with possibly large dimensions, for decorative purposes.

The main objective of the device covered by this patent is to thin a sheet of ornamental stone homogeneously, to the desired thickness and with micrometric precision. This allows the natural rock patterns observed in petrography to be used in the ornamental stone sector, enabling the production, on an industrial scale, of stone sheets and using them as a decorative cladding. The sheets produced are interposed with polarized films and can have a variety of materials and technical characteristics, which are directly associated with the application of the final product.

“TRANSLUCENT NATURAL ROCK SHEET ASSEMBLY APPLIED AS A DECORATIVE CLADDING AND DEVICE AND PRODUCTION PROCESS”, the subject of this patent, was developed to overcome the disadvantage of the small size of petrographic sheet production and make them suitable for use as a cladding, bringing the advantage of being modular, easy to maintain and operate, the production of sheets with various size possibilities and the unprecedented use of petrographic sheets in the ornamental stone sector.

The prior art presents the following problems and technical shortcomings that have been solved by the present invention, shown below:
a. None of the devices presented in the state of the art are capable of producing large petrographic slides, being restricted to small laboratory samples which are generally analyzed under microscopes. Solved by the proposed device using several plungers in series to polish.
b. The petrographic sheets produced by the devices proposed by the state of the art are used strictly as specimens for laboratory analysis, supplying only the production required for research, i.e. their production scale is reduced due to the purpose of their use. This is solved by the proposed device through its customizable dimensions, in which the process is carried out continuously and autonomously.
c. It can be seen that none of the machines and technologies currently available in the field of ornamental stone are capable of cutting or polishing rock sheets with thicknesses of less than 1 mm, most of which are used to split blocks into sheets for later processing and use in the construction sector, with the end products being sinks, tables, benches, etc. Solved by the new process developed, in which the rock to be cut is glued to a support plate.
d. Of the state-of-the-art thinning devices used to supply the ornamental stone market, none are very precise. This is solved by the device's thickness regulation system, which makes it possible to change the thinning level with micrometric precision.

The inventor, with his vast academic experience in geology, observed in laboratory tests that the rock patterns observable when polarized light falls on a petrographic slide are aesthetically pleasing. After carrying out research into the use of these slides in the ornamental stone sector, the inventor determined that this area represents a niche market that has not yet been filled. Having determined the economic viability of the project, the inventor was faced with the reality that none of the current machines have the capacity to produce stone sheets large enough to make it viable to market them as decorative cladding, and so began his own research and development.

For a rock to become translucent, its thickness must be less than 0.05 mm, depending on its composition, while cutting and thinning machines commonly used in the ornamental stone sector produce sheets with a minimum thickness of 2 cm. The machines used in the laboratory, on the other hand, which offer high enough precision to reduce the thickness of a stone to the point required, produce sheets with a surface area of less than 20 cm². In order to overcome these adversities, the inventor began researching viable alternatives to develop a device capable of obtaining a product of adequate proportion, and was unexpectedly inspired by observing the operation of a wood thickness planer.

Therefore, the development of a new system began, using a mobile conveyor belt that takes a rock sheet to a module with a plunger of adaptable size, which reduces its thickness. The system with the plunger was coupled to a precise height gauge and then several modules were connected in series to allow polishing and thinning to be carried out gradually. Starting the tests, the inventor observed that the thickness reduction was indeed being carried out accurately, but the rock sheet, when it reached a thickness of less than 0.5 cm, became very fragile, and the material disintegrated or cracked with minimal movement.

To solve this problem, the inventor began to use a support plate, made of rigid, colorless material, which is fixed with a glue, also colorless, before the thickness reduction process begins. Initially, the support plate suffered scratches and grooves as it passed through the plungers, but by calibrating the heights and rotations of the plungers to a suitable value, a large translucent rock sheet was finally obtained. The inventor continued to carry out tests after the initial objective was achieved, determining that it is also possible to use flexible materials to produce the rock sheet, enabling the product to form curved profile geometries as long as the materials used as support and protection sheets are flexible, without breaking, for example PET and acrylic sheets.

Finally, the sheets produced were sandwiched between two polarized films, with their polarization planes oriented perpendicular to each other and positioned alternately on each side of the sheet. At the end of the process, a cladding was obtained which, when shone on by a light source, shows the dazzling petrographic patterns of colors and textures of the rock initially used.

### BRIEF DESCRIPTION OF THE DRAWINGS

The following figures are provided for better clarification and understanding of the construction:

FIG. 1 illustrates the side view of the thinning device (DDD), making use of six thinning modules (MD);

FIG. 2 illustrates the top view of the thinning device (DDD), representing the position of the rock sheet (CRO) at the start of the process;

FIG. 3 illustrates the top view of the thinning module (MD), partially showing the support grid (PL);

FIG. 4 illustrates the perspective view of the thinning module (MD), emphasizing the end where the rotation of the motor (MT) is transmitted to the abrasive shaft (EA);

FIG. 5 illustrates the perspective view of the thinning module (MD), emphasizing the end where the height handwheel (MDA) adjusts the thinning level;

FIG. 6 is a photo of the sustained rock sheet (LRS) from the thinning of the rock sheet (CRO), in which the sheet with polarized films (LPP) is partially represented, with an example of the pattern of colors and textures that can be generated with the production process; and

FIG. 7 is the exploded view of the set with translucent natural stone sheet applied as a decorative cladding (RD), showing the supported stone sheet (LRS) made up of the stone sheet (LR) joined to a support grid (PS) and the other elements that make up the assembly.

### DESCRIPTION OF THE INVENTION

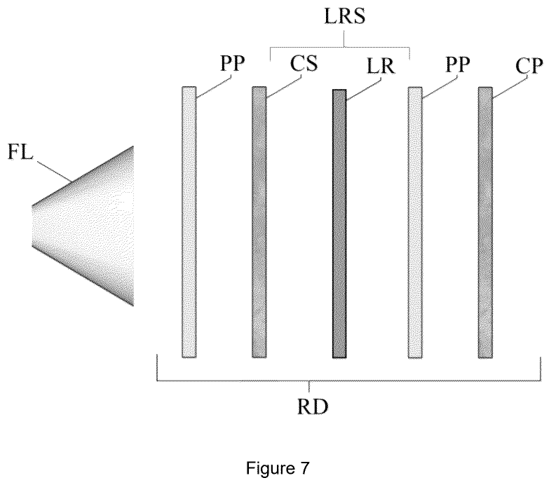

According to FIG. 7, the decorative cladding (RD) is composed of the following elements arranged in sequence, polarized film (PP), supported rock sheet (LRS) formed by joining the transparent support sheet (CS) and rock sheet (LR), polarized film (PP) and a transparent protection sheet (CP); a translucent colorless adhesive, or similar, is used to join all the components of the decorative cladding (RD).

The polarized films (PP) must be oriented so that their direction of polarization is perpendicular to each other, so that the direction of vibration of the polarizers forms an angle of 90°.

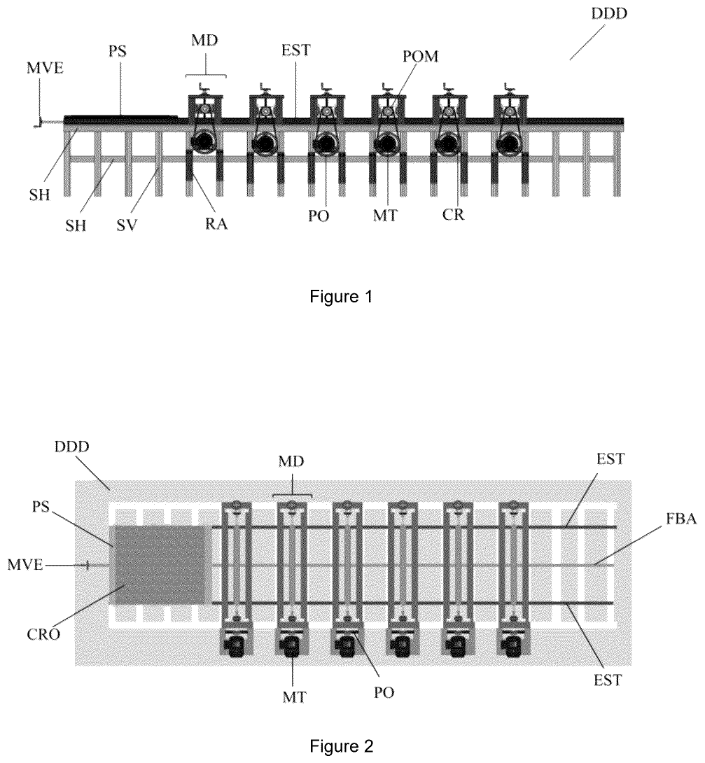

According to FIGS. 1 and 2, the thinning device (DDD) is equipped with a plurality of vertical support beams (SV), made of metal, and with a plurality of horizontal support beams (SH), made of metal, which are connected by bolts or, alternatively, by welding, forming a structure; equipped with conveyor belts (EST), preferably polymeric, by belt or similar, fixed parallel to the upper horizontal support beams (SH) so that the conveyor belt (EST) is able to move the support grid (PS) through the thinning modules (MD); fitted with a metal feed bench spindle (FBA), the length of which varies according to the number of thinning modules (MD), connected at one end to a generic conveyor belt handwheel (MVE), which can optionally be connected to a conveyor belt motor, not shown; equipped with a support grid (PS), polymeric or metallic, rectangular in shape with dimensions that accommodate the rock sheet (CRO) to be thinned, which is supported on the conveyor belts (EST) and the horizontal skids (PAH); equipped with a plurality of horizontal skids (PAH), preferably with a flap, fixed below the conveyor belt (EST), helping to support the support grid (PS); and is equipped with a plurality of thinning modules (MD) positioned orthogonally to the direction of conveyor belt flow (EST), above the structure formed by the vertical support beams (SV) and horizontal support beams (SH).

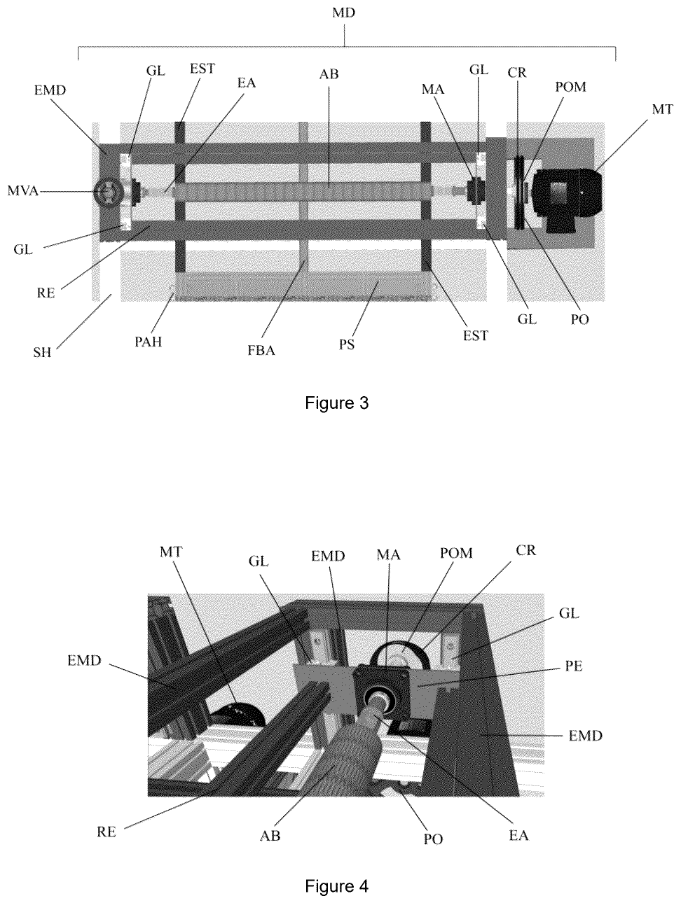

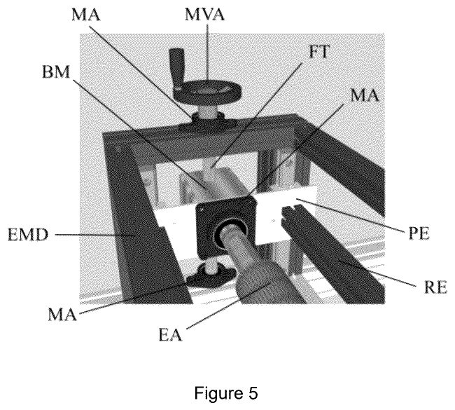

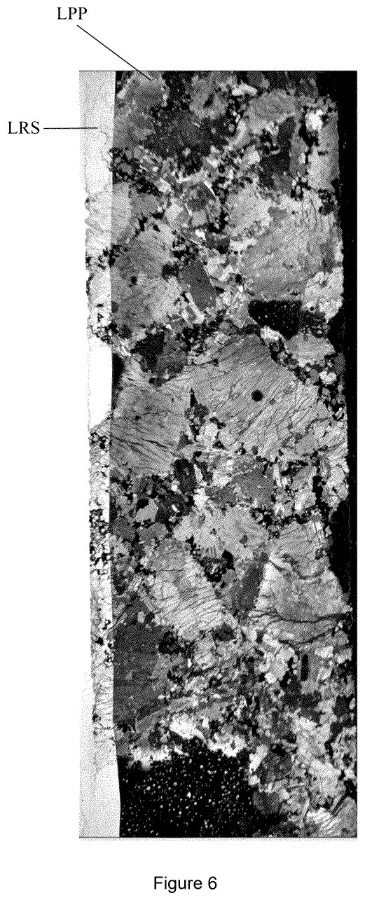

According to FIGS. 3, 4 and 5, the thinning module (MD) contains a height adjuster (RA), preferably metal, connected to the upper ends of the lower vertical support beams (SV); it contains a motor (MT), three-phase or similar, fixed to the vertical support beams (SV), above the horizontal support beam (SH); contains a pulley (PO), polymeric or metallic, preferably with a channel in its circumference consistent with a belt (CR), fixed to the rotation axis of the motor (MT); contains a smaller pulley (POM), metallic, of smaller diameter than the pulley (PO), with a speed increase factor of 3:1 or higher, connected to one end of the abrasive shaft (EA) and connected to the pulley (PO) via a belt (CR); contains a structure (EMD), made up of a plurality of metal beams forming a rectangular geometry and with legs perpendicular to their vertices, fixed above the upper horizontal support beam (SH); contains an abrasive shaft (EA), preferably metal, which passes through the center of the abrasive face circumference (AB), connected at one of its ends to the smaller pulley (POM), and fixed and supported by two bearings (MA); contains abrasive (AB), natural or synthetic, cylindrical in shape and interchangeable according to the finish required; contains structural plates (PE), metal, rectangular in shape, which are fixed centrally to the bearing (MA), fixed to the block (BM) on its face opposite the bearing fixed at the opposite end of the motor (MT) and fixed to two parallel reinforcements (RE) perpendicular to its face; contains two metal structural plates (PE) that support the bearings (MA), positioned at the ends of the reinforcements (RE); contains a plurality of common linear guides (GL), with their moving parts positioned at the ends of the structural plates (PE) and their fixed guide positioned in the vertical part of the structure (EMD); contains a solid, metallic, polygonal block (BM) with an internally threaded through hole in its upper face and a front face of suitable dimensions to help support the bearing bolts (MA), fixed to the structural plate (PE) so that the through hole is vertical; contains a conventional trapezoidal spindle (FT), preferably with a pitch of 4 mm or less, threaded into the through hole of the block (BM), with one of its ends fixed to the height handwheel (MVA) and with its rotation supported by two bearings (MA); contains a conventional metal or polymeric height handwheel (MVA) fixed to the upper end of the trapezoidal spindle (FT).

The height handwheel (MVA) is supported by bearings (MA) and connected to the trapezoidal spindle (FT), allowing the handwheel (MVA) to rotate in a vertical linear movement that adjusts the height of the abrasive shaft (EA). The movement is transmitted to the block (BM), which in turn is coupled to the structural plate (PE) and the abrasive (AB).

To accurately determine the height of the abrasive shaft (AS), a dial indicator is used and attached to the structural plate (PE). Alternatively, electric precision gauges or a handwheel with analog measurements can be used, which can be built directly into the thinning module (MD) of the thinning device (DDD). The thinning modules (MD) have their height changed individually, so that the rock sheet (CRO) is gradually thinned.

### Examples of Embodiments of the Invention

The thinning device (DDD) is installed using the following steps:
1-a) Determine the number of thinning modules (MD) that will be needed according to the type and thickness of the rock sheet (CRO) and determine the width of the modules according to the use of the final product;
1-b) Assemble the base of the thinning device structure (DDD), using vertical and horizontal support beams (SV) and (SH), and install the height adjusters (RA) in the places where the thinning modules (MD) will be installed;
1-c) Install the feed bench spindle (FBA) and the conveyor belts (EST);
1-d) Assemble the structures (EMD) of the thinning modules (MD), attaching the fixed guides of the linear guide (GL) to the inside of their vertical supports;
1-e) Determine the types of abrasives (AB) that will be used and insert the abrasive shafts (EA) inside them;
1-f) Install the bearings (MA) and the moving skid of the linear guide (GL) on the structural plates (PE), adding the block (BM) for the plate corresponding to the side on which the trapezoidal spindle (FT) will be installed;
1-g) The abrasive shaft (EA) is installed between two structural plates (PE), one of which has the block (BM) attached, fixing the shaft (EA) to the bearings (MA), then two reinforcements (RE) are installed parallel to the shaft;
1-h) The previously assembled frame (EMD) is fixed on top of the base of the thinning device frame (DDD), above the height adjusters (RA);
1-i) Slide the skids of the abrasive shaft assembly (EA) and structural plates (EA) onto the guide (GL) inside the structure (EMD);
1-j) Position the handwheel height manipulator (MVA) and the trapezoidal spindle (FT) through the frame (EMD) and the block (BM);
1-k) Install the motor (MT) and the pulley (PO) on the height adjusters (RA) and install the smaller pulley (POM) on the abrasive shaft (EA), connecting both via a belt (CR), the slack of the belt (CR) is adjusted via the height adjusters (RA); and
1-l) The horizontal skids (PAH) are attached to the support grid (PS) and the grid (PS) is then positioned on top of the conveyor belt (EST).

In order for the rock sheet (CRO) to be reduced in thickness to a micrometric scale, without falling apart when it is removed from the machine, a preparation process is used in which the rock is fixed, using a translucent colorless glue, to a support sheet (CS), also translucent, which can be made of materials such as plastic, acrylic, glass or equivalent, supporting both flexible and rigid elements.

To ensure a good finish on the rock sheet (LR), the abrasive grain size (AB) is increased sequentially and the grinding depth is reduced as it passes through each abrasive module (MR), so that the linear grinding and polishing process takes place in a single process, reducing the need for rework.

The rock sheet (LR) must be thin enough for the anisotropic minerals contained in a given rock to become translucent, allowing light to pass through its crystallographic structure. Therefore, for the purposes of this patent, the ideal thickness of a rock sheet (LR) varies depending on the type of rock chosen, taking into account the degree of translucency of its constituent minerals. The sheet of translucent natural stone (LR) may have different geometric shapes, as long as its dimensions (width×length) are sufficient for the purpose of this patent, which is its application as a decorative cladding.

The operation of the thinning device (DDD) follows these steps:
2-a) The rock sheet (CRO), already glued to a colorless support plate and positioned above the support grid (PS), advances with the movement of the conveyor belt (EST) to the first thinning module (MD);
2-b) The abrasive (AB), with its previously calibrated height, rotates and removes material from the surface of the rock sheet (CRO), while at the same time a flow of running water removes the grinding residue and cools the abrasive;
2-c) The rock sheet (CRO) passes sequentially through all the thinning modules (MD), having its thickness gradually reduced to avoid damaging the resulting rock sheet (LR); and
2-d) After going through the last thinning module (MD), the rock sheet (LR) is removed and goes through a drying process, finally, polarized films (PP) and the protection sheet (CP) are glued on both sides to form a decorative cladding (RD).

The decorative cladding (RD) will have its optical effects generated by the interaction of the two polarized films (PP) and the sheet of rock (LR) with the incidence of a light source (FL), providing the observer with an aesthetic pattern of colors and textures in the minerals contained in the sheet of rock (LR). This aesthetic pattern, with dynamic colors and unusual textures, is completely different when compared to the same sheet of rock (LR) seen in natural light, is configured as a new type of cladding, hitherto unheard of in the ornamental stone sector and civil construction in general. Given the shape, the diversity of existing stone types, the thickness of the stone sheet (LR) and the various types of light sources (FL) that can be used, a multitude of creative ideas for models and applications for the decorative cladding (RD) created will emerge.

For the visual effect to be observed, a light source (FL) must be positioned so that the decorative cladding (RD) is backlit, preferably by positioning the light source (LD) on the back of the decorative cladding (RD), where the polarized film is exposed, as shown in FIG. 7, and the protection plate (CP) must be externally visible, thus performing its function of protecting the polarized film (PP) from damage. Alternatively, you can use two protection plates (CP), attaching them to both sides of the decorative cladding (RD).

The color pattern can vary according to the type of mineral and the thickness of the stone slab. Therefore, at the stage of making the stone sheet (LR), you can choose its thickness to determine the desired color pattern for the cladding, i.e. the same stone sheet (LR) can have different color patterns depending on its thickness. The appropriate thickness can be determined using the Michel-Lévy color chart.

1. A decorative cladding with application in the ornamental stone sector, wherein the decorative cladding (RD) is made up of the following elements in sequence: polarized film (PP), supported stone sheet (LRS) formed by joining the transparent support sheet (CS) and stone sheet (LR), polarized film (PP) and transparent protection sheet (CP), Alternatively, you can use two protection sheets (CP), as the first and last element, using a translucent colorless adhesive, or similar, to join all the components of the decorative cladding (RD);

2. The decorative cladding according to claim 1, wherein the type of sheet slab (CR) transformed into sheet rock (LR) is composed partly or wholly of anisotropic minerals, has a sheet thickness thin enough for the anisotropic minerals constituting the rock to become translucent, and that the sheet has sufficient dimensions for the decorative cladding (RD) to meet its designated use.

3. The decorative cladding according to claim 1, wherein the decorative cladding (DR) has different geometric shapes, depending on the type and shape of the object on which said cladding is applied.

4. (canceled)

5. A device for the production of translucent natural rock sheets used in the thinning of rock sheets (CRO), wherein the thinning device (DDD) is equipped with a plurality of vertical support beams (SV), metallic, and equipped with a plurality of horizontal support beams (SH), metallic, which are connected by screws or, alternatively, welding, forming a structure; equipped with conveyor belts (EST), preferably polymeric, by belt or similar, fixed parallel to the upper horizontal support beams (SH) so that the conveyor belt (EST) is able to move the support grid (PS) through the thinning modules (MD); fitted with a metal feed bench spindle (FBA), the length of which varies according to the number of thinning modules (MD), connected at one end to a generic belt handwheel manipulator (MVE), which can optionally be connected to a belt motor; equipped with a support grid (PS), polymeric or metallic, rectangular in shape with dimensions that accommodate the rock sheet (CRO) to be cleared, which is supported on the tracks (EST) and the horizontal skids (PAH); equipped with a plurality of horizontal runners (PAH), preferably with a flap, fixed below the conveyor belt (EST), helping to support the support grid (PS); and equipped with a plurality of thinning modules (MD) positioned orthogonal to the direction of conveyor flow (EST), above the structure formed by the vertical support beams (SV) and horizontal support beams (SH);
The thinning module (MD) contains a height adjuster (RA), preferably metallic, connected to the upper ends of the lower vertical support beams (SV); it contains a motor (MT), three-phase or similar, fixed to the vertical support beams (SV), above the horizontal support beam (SH); it contains a pulley (PO), polymeric or metallic, preferably with a channel in its circumference consistent with a belt (CR), fixed to the rotation axis of the motor (MT); contain a smaller metal pulley (POM), smaller in diameter than the pulley (PO), with a speed increase factor of 3:1 or higher, connected to one end of the abrasive shaft (EA) and connected to the pulley (PO) via a belt (CR); contain a frame (EMD), made up of a plurality of metal beams forming a rectangular geometry and with legs perpendicular to their vertices, fixed above the upper horizontal support beam (SH); contain an abrasive shaft (EA), preferably metal, which passes through the center of the circumference of the abrasive face (AB), connected at one of its ends to the smaller pulley (POM), and fixed and supported by two bearings (MA); contain abrasive (AB), natural or synthetic, cylindrical in shape and interchangeable according to the finish required; contain structural plates (PE), made of metal, in the shape of rectangular plates, which are fixed centrally to the bearing (MA), fixed to the block (BM) on its opposite side to the bearing fixed to the opposite end of the motor (MT) and fixed to two parallel reinforcements (RE) perpendicular to its side; contain two metal structural plates (PE), which support the bearings (MA), positioned at the ends of the reinforcements (RE); contain a plurality of common linear guides (GL), with their moving parts positioned at the ends of the structural plates (PE) and their fixed guide positioned in the vertical part of the structure (EMD); contain a block (BM), solid and metallic, polygonal with a through hole and internally threaded on its upper face and a front face with adequate dimensions to help support the bearing bolts (MA), fixed to the structural plate (PE) so that the through hole is vertical; contain a conventional trapezoidal spindle (FT), preferably with a pitch of 4 mm or less, threaded into the through hole of the block (BM), with one of its ends fixed to the height handwheel (MVA) and with its rotation supported by two bearings (MA); contain a conventional metal or polymeric height handwheel (MVA) fixed to the upper end of the trapezoidal spindle (FT).

6. The device for the production of translucent natural rock sheets according to claim 5, wherein the precise determination of the height of the abrasive shaft (AS) through the use of dial gauges, electrical precision gauges or a handwheel with analogue measurements, which can be built directly into the thinning device (DDD).

7. The device for the production of translucent natural rock sheets according to claim 5, wherein the thinning modules (MD) can be added to the thinning device (DDD) as needed.

8. The device for the production of translucent natural rock sheets according to claim 5, wherein the rock sheet (CRO) passes sequentially through all the thinning modules (MD), having its thickness gradually reduced to avoid damaging the rock sheet (LR).

9. The device for the production of translucent natural rock sheets according to claim 8, wherein the granulometry of the abrasives (AB) increases sequentially, as well as the grinding depth is reduced, when passing through each abrasive module (MR), so that the grinding and polishing process takes place in a single process, reducing the need for rework.

10. An assembly with translucent natural rock sheet applied as a decorative cladding wherein the application of petrographic sheets in the ornamental stone sector as a cladding.
